(19) United States
(12) Patent Application Publication
(10) Pub. No.: US 2024/0237625 A1
(43) Pub. Date: Jul. 18, 2024

(54) Method and Apparatus for Cleaning Aquarium Substrate

(71) Applicant: Jonathan Allen Hayes, Raleigh, NC (US)

(72) Inventor: Jonathan Allen Hayes, Raleigh, NC (US)

(21) Appl. No.: 18/412,475

(22) Filed: Jan. 13, 2024

Related U.S. Application Data
(60) Provisional application No. 63/479,985, filed on Jan. 13, 2023.

(51) Int. Cl. A01K 63/10; A01K 63/04; H02J 50/10

(52) U.S. Cl. CPC A01K 63/10; H02J 50/10; A01K 63/045; A01K 63/047

(57) ABSTRACT

An aquarium substrate cleaning system, including one or more motion-generating elements positioned within or beneath the aquarium substrate and a power and control system to control the activation and intensity of the motion-generation elements. The system allows for automated, hands-off maintenance and cleaning of substrates such as aquarium sandbeds. The motion from the device disrupts and liberates detritus from the substrate, allowing it to be removed by the water column.

### CROSS-REFERENCE TO RELATED APPLICATIONS

The present application claims the benefit of U.S. Provisional Application No. 63/479,985 filed Jan. 13, 2023, which is not admitted to be prior art with respect to the present invention by its mention in the cross-reference section.

### BACKGROUND OF THE INVENTION

In typical aquarium applications, an applied substrate is used for aesthetic beauty and other beneficial use. Aquarium substrates are often formed by placing a layer of sand (creating a “sandbed”), gravel, crushed coral or other materials onto the bottom surface of the inside of the aquarium container (each an “applied substrate”). Sometimes the aquarium is styled in a “bare-bottom” fashion, meaning that no additional bulk surface material is applied inside the aquarium, or a that a typically solid and flat material such as a plastic board (an “applied floor”) is used simply to cover and protect the delicate bottom surface of the inside of the aquarium from damage that might occur from falling rocks or other hazards. As a result, the substrate layer of a bare-bottom aquarium can simply be the top surface of the bottom layer of the material of the aquarium enclosure, often glass or acrylic, including an applied floor, if present (an “aquarium floor”). The bottom layer(s) inside an aquarium, including the aquarium floor, the applied substrate, if any, and the space between the aquarium floor and the open water column, will be referred to herein as the “substrate”. The typical use of substrates is similar in both saltwater and freshwater aquarium applications.

Circulation of the water column is a typical feature of nearly all functioning aquariums, as it is necessary to the survival of most desirable aquarium life, such as many types of fish and corals. Typical water movement (aquarium “circulation”) assists in moving oxygen throughout the water column (“aerating”) and maintaining appropriate water chemistry, both of which are either beneficial or necessary for most types of typical aquarium livestock. This circulation generally occurs via standard “circulation pumps” which may be placed inside the aquarium, “return pumps” (which circulate water between a sump or secondary fluid container which houses filtration equipment and the primary fluid container, which typically houses aquarium livestock). Circulation of the water column can also be generated by the swimming motion of tank inhabitants, and external filtration equipment, such as canister filters. The water column is generally the portion of water above the substrate. The water column is typically in constant motion in response to the methods of circulation described above. Small amounts of water beneath and inside the substrate layer are generally not regarded as a part of the water column.

Aquarium substrates frequently serve as a home for aquatic life. This can include larger aquatic lifeforms, such as various species of fish that position themselves beneath the surface of, for example, a sandbed, either for protection, to hide, to find food, to nest, or for rest. Substrates are also often the home to various microscopic life forms such as bacteria (including beneficial bacteria), worms, small crustaceans, algae and various plankton.

Sometimes various undesirable organic and/or inorganic materials may accumulate in the substrate over time, particularly in granular applied substrates like sand and gravel. For example, uneaten food intended for aquarium inhabitants can get trapped in the substrate and cause the substrate to appear unclean. Unwanted waste or debris in the substrate is referred to herein as “detritus”. In addition to presenting the aesthetic concern of the detritus itself, detritus left on or in the substrate can break down into compounds such as ammonia, which can be harmful to aquatic inhabitants. It has been suggested that, over time, the accumulation and subsequent breaking down of detritus in substrates of certain depths (a few inches or more) can lead to a buildup of other toxic gasses that, when later released, could harm aquarium inhabitants. Detritus can also encourage the growth of unwanted organic life, forming within or on the surface of the substrate, further reducing the beauty of the aquarium.

To prevent the undesirable outcomes that can result from a buildup of material in and on the aquarium substrate, maintenance of the substrate is required. This maintenance sometimes includes populating the aquarium with various species of fish or other aquatic inhabitants that can assist with detritus removal. Sometimes these inhabitants will consume or extract the detritus. Sometimes they will move through the substrate, mixing the substrate in the process and liberating trapped detritus into the water column. While it requires little effort from the aquarium operator, this approach can be limiting because of compatibility issues between aquarium inhabitants, incomplete and inconsistent cleaning of the substrate, low reliability of the inhabitants to significantly mix the substrate, and the limited availability and variety of potential aquarium inhabitant that can perform this service, among others factors.

Alternatively, maintenance can be performed manually by the aquarium operator. This is typically performed with a rake, a baster or another tool used to sweep or move around the substrate and liberate detritus into the water column. Still other methods involve using suction to vacuum the detritus from above, simultaneously removing water into a waste area. Each of these methods requires tedious manual intervention by the aquarium operator to be performed regularly for the life of the aquarium. Because manual work is required, this important maintenance is often neglected or performed infrequently, leading to subpar outcomes for the health and beauty of the aquarium.

### SUMMARY OF THE INVENTION

This invention is a novel method and apparatus for cleaning the substrate in an aquarium. The method includes generating movement from beneath or within the substrate layer via an embedded device. The motion generated by the device liberates detritus into the water column above the substrate, allowing the detritus to be swept away by the circulation of the aquarium and removed through the aquarium's other systems (e.g. filter pads, filter socks, skimmers, canister filters, sumps, eaten by inhabitants, etc.). The motion that is generated causes water from the water column to be mixed into the substrate layer. The required motion can be generated in a variety of ways, including, but not limited to a) motors that directly push on the substrate material, b) propellers which push water through the substrate, c) bubblers which push gas through the substrate material, and d) acoustic vibrations which vibrate the substrate.

This invention reduces or eliminates the burden of active, manual maintenance of the aquarium substrate, creating an automated cleaning solution and allowing for a more aesthetically pleasing and potentially healthier aquarium.

### BRIEF DESCRIPTION OF DRAWINGS

FIG. 1 is a plain view of an embodiment of the apparatus

FIG. 2 is a top-down view of an embodiment of the apparatus

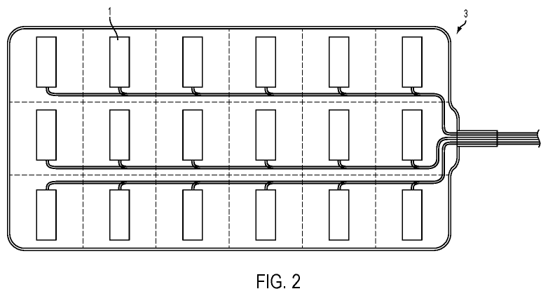

FIG. 3 is an exploded view of an embodiment of the apparatus

FIG. 4 is a view of an embodiment of the apparatus in use in an aquarium

FIG. 5 is an exploded view of an alternative embodiment of the apparatus

FIG. 6 is a view of an alternative embodiment of the apparatus in use in an aquarium

### DETAILED DESCRIPTION OF THE INVENTION

The invention comprises a power and control system and one or more motion-generating elements (“MGEs”). It may also include an optional sleeve or housing. This controllable device can be positioned beneath or within the substrate layer, generating motion through the substrate in an aquarium, such that detritus can be released from the substrate and accumulation of detritus can be reduced. It can optionally be incorporated into the aquarium floor, such as at the time of manufacture of the aquarium or be built as a separate unit that is subsequently placed inside the aquarium to rest atop the surface of the aquarium floor, beneath an applied substrate. In the case of a bare-bottom aquarium, the device itself can serve as an applied floor, and is therefore a part of and itself within the substrate.

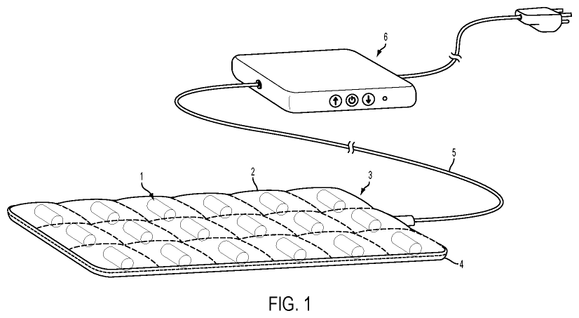

FIG. 1 depicts a possible embodiment of the apparatus. 1 depicts one or more MGEs. FIG. 1 depicts waterproof Eccentric Rotating Mass (ERM) vibrating motors as the MGEs inside a sleeve 3. The rocking back and forth of the motors comprises the motion of the MGE in this embodiment, causing shifting in the substrate above, liberating detritus into the water column and ultimately cleaning the substrate.

The typical implementation positions a plurality of MGEs in an intentionally spaced configuration. Each MGE is intended to provide motion to agitate a section of substrate above. In doing so, the MGE helps to prevent that section of substrate from accumulating detritus. MGEs may be wired together in series, in parallel, or individually wired, for various controllability outcomes. Use cases for various wiring configurations include allowing for separately controlled MGEs and/or collectively controlled MGEs. A group of, for example, six motors could activate together, while other motors can remain off; or a group of one or more MGEs may be set to 20% intensity while others are set to 80% intensity.

In certain embodiments of the apparatus, various types of MGEs could be mixed in with other types of MGEs. For example, groups of ERM vibrating motors could be mixed with groups of bubblers.

As depicted in FIG. 1, a sleeve cover 2 and a sleeve base 4 can be optionally utilized to provide structural containment of the MGEs and associated components. The sleeve cover 2 separates the MGEs from direct contact with the substrate above, allowing freer movement of the MGEs, and can be made of materials such as water-tolerant fabrics, like neoprene. The embodiment illustrates a stitched pattern to isolate free space for movement of the MGE in this implementation. Line 3 depicts an embodiment of the “sleeve”, comprising the sleeve cover 2, sleeve base 4, and encapsulated MGEs and associated components 1. In a “corded” embodiment, an insulated cable 5 allows the direct transfer of electricity between the array of MGEs and the power and control system housed in a control box 6.

In a possible embodiment, the power and control system 6 allows for both “on/off” activation as well as an ability to manipulate the intensity along a spectrum from 0-100% intensity for each MGE or collectively wired group of MGEs. At lower intensities, the motion generated by the MGE is less substantial than the motion generated at a higher intensity. This can be accomplished by the power and control system by, for example, regulating the voltage applied to the motors driving the MGEs. The power and control system allows for the activation of the MGEs to occur programmatically and set to a schedule in addition to activation on demand. The scheduling functionality provides that the MGEs can be activated throughout the day at the user's discretion, including at night or when tank viewing may be less frequent, and including at a frequency of the user's choosing (e.g. every hour for 10 minutes).

A typical implementation of the power and control system 6 may include a housing or enclosure with internal circuit board(s) governing the control of the apparatus and management of the power supplied to the MGEs. The enclosure may provide a user interface to activate MGEs and increase or decrease intensity of MGEs.

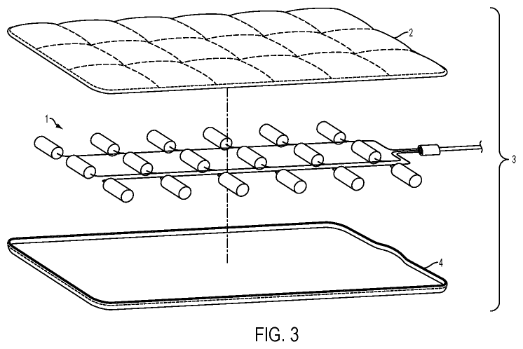

FIG. 3 illustrates an exploded view of an embodiment of the apparatus with various ERM motor MGEs. The spacing of the MGEs 1 is intended to optimize the amount and even distribution of motion transferred to the substrate above, for the best cleaning outcome. Sleeve base 4 provides weight, traction to the aquarium floor to minimize movement of the sleeve itself, aesthetic appeal, and additional protection of the MGEs from the surrounding aquarium elements, such as sand and gravel or livestock. The sleeve base also helps to dampen unnecessary downward vibration, and it provides a base for the placement of the MGEs.

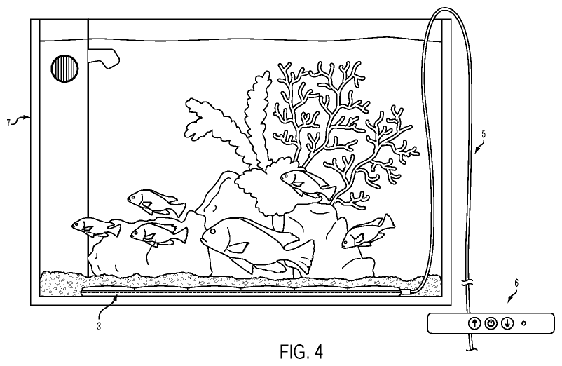

FIG. 4 illustrates a corded embodiment of the apparatus with the sleeve 3 embedded within the sandy substrate of the aquarium. The sleeve is depicted positioned at the bottom of a glass aquarium 7, largely covering the bottom surface of the aquarium, and is covered with one to two inches of aquarium sand, a few rocks, and other decorative aquarium items. When activated by the power and control system 6, the MGEs will generate motion, causing movement and shifting in the sand particles above the sleeve. The movement will allow some water from the water column to intermix with the moving surface of the sandy substrate. As the shifting sand moves around, detritus that was previously lodged into the sandbed will be exposed and released into the water column above. Once in the water column, a fraction of that detritus may be removed by the aquarium's existing filtration systems or eaten by aquarium inhabitants. Some fraction of the detritus may resettle in or on the substrate. Said detritus can be again liberated into the water column via movement of the MGEs. Over multiple iterations, an increasingly large fraction of the original detritus is removed. Where the substrate is a fine granular substrate, such as sand, this “turning over” of the sandbed leaves it cleaner and makes the substrate less hospitable for certain bacteria and algae, reducing the establishment of unsightly blooms.

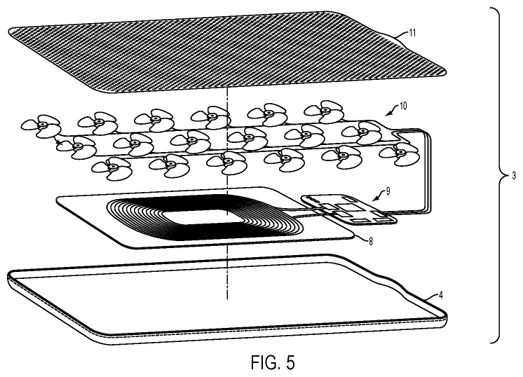

FIG. 5 illustrates an embodiment of a sleeve 3 with a preferred “wireless” configuration, with an alternate sleeve cover 11, and an alternate MGE 10 selection. The fact that the sleeve is configured for wireless power transfer is not intended to imply a restriction on the MGE selection. The ERM vibrating motor MGEs could just as easily be configured for wireless power transfer, as could other MGE selections. Likewise, the sleeve cover material is not necessarily determined by the power supply configuration.

The MGEs illustrated in FIG. 5 are rotating propellers driven by small waterproofed electric motors. Powering the motors causes the propellers to spin, in turn causing the movement of surrounding water to push upward into and through the substrate above. This motion of water through the substrate causes detritus lodged in or settled atop the substrate to be liberated into the water column, where it can be swept away by the aquarium's circulation and removed by the aquarium's filtration systems or eaten by aquarium inhabitants.

The sleeve 3 in FIG. 5 also depicts an alternate sleeve cover 11. In this embodiment, the cover is a mesh screen. This can be made of aquarium tolerant metal, nylon, or other material. The openings in the mesh are small, for example approximately 60 microns in diameter. This allows the passage of water through the mesh but blocks most solid material, such as grains of sand or gravel and detritus. In such a configuration, a small “lagoon” of water is created inside the sleeve itself. When activated the MGEs begin to move freely in the surrounding water. The motion generated by the propellers directly moves this separate body of water up and through the holes in the mesh screen cover and, in turn, transfers that motion into the substrate above.

The sleeve 3 in FIG. 5 also depicts an alternate configuration of the power supply to the MGEs. Whereas FIG. 1 contemplates a “corded” application, ultimately supplying power via a hard-wired connection to an electrical outlet, this alternate configuration contemplates a “wireless” power supply. A wireless power supply module 8, such as those used in wireless cell-phone charging units, is embedded within the sleeve. The onboard power source circuitry 9 is now embedded within the sleeve. The wireless power supply module can optionally charge an onboard power storage, such as a lithium-ion battery, which may be included in the onboard power source circuitry 9, indirectly supplying power to the MGEs via such onboard power storage. The wireless power supply module can optionally directly supply power to the MGEs.

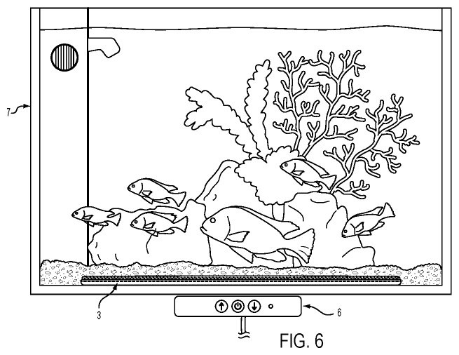

Wireless powering of the apparatus is possible via inductive transfer, resonance transfer, uncoupled transfer, or other wireless electricity transfer method. In a possible embodiment as depicted in FIG. 5, the wireless powering of the MGEs in the sleeve occurs via wireless, electromagnetic power transfer. In such a system, a “transmitting” unit receives power, typically from a mains power line, and converts that power into a time-varying magnetic field, which then received and converted back into electrical current by the “receiving” unit in the onboard power supply module 8 shown in FIG. 5. This electrical current is then used to provide electric power to the MGEs. The corresponding “transmitting” unit can be placed inside the aquarium floor, or as depicted in FIG. 6 line 6, below the bottom pane of the aquarium, typically inside of an aquarium stand or cabinet.

The incorporation of the onboard power supply has several benefits. First, it allows for the removal of a direct wired connection between the power and control system and the sleeve. This is particularly desirable in the aquarium, where cords are considered an unsightly distraction from the viewing experience. FIG. 6 depicts an embodiment of the “wireless/propeller MGE/mesh sleeve cover” configuration in use inside an aquarium 7, highlighting the improved visual aesthetic. This configuration also allows for more uninterrupted swimming space for aquarium inhabitants.

Components depicted within the sleeve 3 can be effectively waterproofed by coating and sealing the electronic components with various materials including epoxies, silicones, glues, acrylics, or other coatings and sealants.

The power and control system is contemplated to be optionally controllable remotely, via a software application. A typical implementation includes a mobile app, allowing the user to see the status of the device and the various MGEs, including their intensity and current and scheduled active status. The remote control are also contemplated to allow convenient scheduling and manipulation of the activity and intensity of the MGEs.

Clearly, based on the foregoing description, the present invention is a useful and novel method and apparatus for cleaning the substrate in aquariums. The present invention presents several advantages over the prior art, including:

Providing for easier, less-labor intensive cleaning of the substrate.

Providing for scheduled automated cleaning of the substrate.

Providing for a more reliable, more consistent, and more frequent cleaning of the substrate.

Providing for a better cleaning of the substrate, driven by motion that flows through the depth of the substrate.

In the foregoing description and referenced drawings, the present invention has been described and/or illustrated with reference to certain “preferred”, “alternative” and other embodiments thereof. These descriptions and illustrations are not intended to be exhaustive or to limit the invention solely to the precise embodiments disclosed. These embodiments were chosen to best illustrate the essential principles of the invention such that a person of ordinary skill in the art could utilize the invention in various embodiments and with various modifications as may be appropriate within the spirit of the invention. It will be evident that various modifications may be made thereto which would not depart from the spirit and scope of the present invention, as indicated by the accompanying claims.

1. An apparatus for cleaning a substrate within an aquarium comprising:
one or more motion-generating elements embedded within or beneath the substrate;
a power and control system to control the motion-generating elements.

2. The apparatus as described in claim 1, wherein said motion-generating elements are contained within a sleeve or housing.

3. The apparatus as described in claim 1, wherein said motion-generating elements further comprise one or more vibrating motors.

4. The apparatus as described in claim 1, wherein said motion-generating elements further comprise one or more rotating propellers.

5. The apparatus as described in claim 1, wherein said motion-generating elements further comprise bubblers which emit gaseous bubbles to move through the substrate.

6. The apparatus as described in claim 1, wherein said motion-generating elements further comprise one or more acoustic vibrating elements and generate sound waves, whether audible or inaudible.

7. The apparatus as described in claim 1, wherein said power and control system further comprises a scheduler to control activation, deactivation and varying levels of relative intensity of the motion-generating elements.

8. The apparatus as described in claim 1, wherein said power and control system further comprises a controller to alter the intensity of the motion-generating elements in any range between 0 to 100% intensity.

9. The apparatus as described in claim 1, wherein said power and control system further comprises a wireless power supply.

10. The apparatus as described in claim 1, wherein said power and control system further comprises a software application enabling remote control of the apparatus.

11. The method of utilizing motion-generating elements embedded within or beneath the substrate of an aquarium to clean said substrate, comprising:
Providing one or more motion-generating elements;
Providing a power and control system to control the motion-generating elements;
Positioning the motion-generating elements within or beneath the substrate;
Activating the power and control system;
Utilizing the motion generated by the motion-generating elements to disrupt the substrate and dislodge detritus from within and atop the substrate into the water column;
Operating a pump to provide circulation within the aquarium;
Implementing a form of mechanical, chemical, or biological filtration to remove detritus from the water column.
